(19) United States
(12) Patent Application Publication
(10) Pub. No.: US 2014/0033121 A1
(43) Pub. Date: Jan. 30, 2014

(54) SYSTEM AND METHOD FOR MANAGING DISPLAY OF GRAPHICAL USER INTERFACE IN ELECTRONIC DEVICE

(71) Applicant: HON HAI PRECISION INDUSTRY CO., LTD., New Taipei (TW)

(72) Inventors: TIEN-CHIEH KUO, New Taipei (TW); CHENG-YI KUO, New Taipei (TW)

(73) Assignee: HON HAI PRECISION INDUSTRY CO., LTD., New Taipei (TW)

(21) Appl. No.: 13/887,385

(22) Filed: May 6, 2013

(30) Foreign Application Priority Data
Jul. 26, 2012 (TW) 101126889

(51) Int. Cl. G06F 3/048

(52) U.S. Cl. CPC G06F 3/048
USPC 715/804

(57) ABSTRACT

A method of managing display of a graphical user interface includes reading parameters of panes designed in the GUI, and calculating a coordinate set comprising coordinates of four vertexes of each of the panes according to the read parameters, and recording the coordinate set according to a predetermined format. The method further mark an order of each of the panes in a predetermined mode, and storing the parameter of each of the panes according to the marked order. When the GUI is displayed on a display device, the method displays the panes of the GUI according to the marked order from a storage system of the electronic device.

### BACKGROUND

1. Technical Field

Embodiments of the present disclosure relate to graphical user interface (GUI), and particularly to a system and a method for managing display of a GUI in an electronic device.

2. Description of Related Art

In a traditional method of designing a graphical user interface (GUI), size of a layout of the GUI needs to be declared and defined in programs in advance. Furthermore, a display position and a size of each pane of the layout are also need to be defined in advance. However, the display and the size of each pane of the layout are generally already pre-defined. Therefore, the design of the GUI may lack diversification and individualization, as there is no clear location and display method about the panes of the layout.

### BRIEF DESCRIPTION OF THE DRAWINGS

FIG. 1 is a block diagram of one embodiment of an electronic device including a management system.

FIG. 2 is a block diagram of one embodiment of function modules of the management system in FIG. 1.

FIG. 3 is a flowchart illustrating one embodiment of a method for managing display of GUI of an electronic device.

FIG. 4 is a flowchart illustrating one embodiment of a method of marking panes in the GUI.

FIG. 5A and FIG. 5B are schematic diagrams of one embodiment of marking the panes in the GUI.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware unit, or to a collection of software instructions, written in a programming language. One or more software instructions in the modules may be embedded in firmware unit, such as in an EPROM. The modules described herein may be implemented as either software and/or hardware modules and may be stored in any type of non-transitory computer-readable medium or other storage device. Some non-limiting examples of non-transitory computer-readable media may include CDs, DVDs, BLU-RAY, flash memory, and hard disk drives.

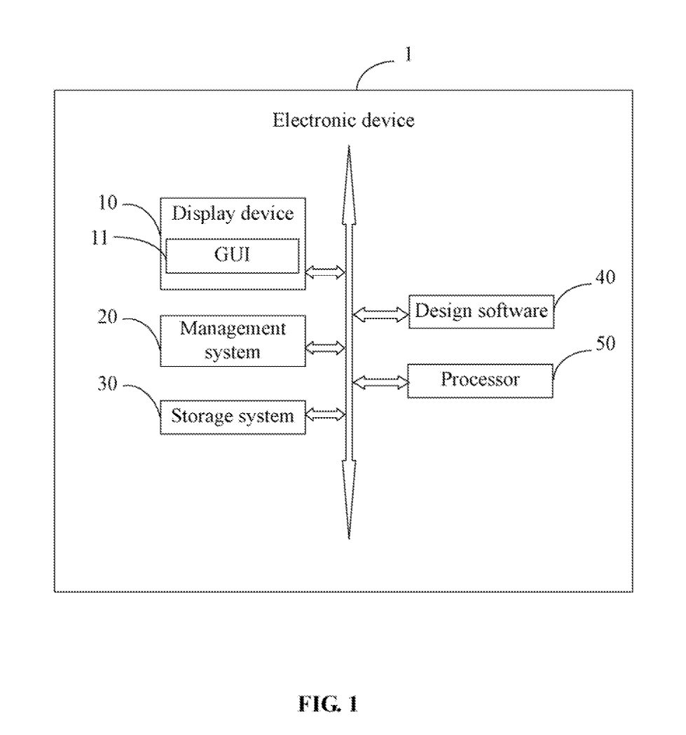

FIG. 1 is a block diagram of one embodiment of an electronic device 1. The electronic device 1 includes a display device 10, a management system 20, a storage system 30, design software 40, and at least one processor 50. The display device 10 displays a graphical user interface (GUI) 11. The design software 40 arranges a layout of the GUI 11. The layout of the GUI 11 includes a plurality of panes. The panes may be icons of videos or menus of the electronic device 1. Size of the layout arranged by the design software 40 is not restrictive, and a size and a position of each of the panes do not need to be defined in advance. The design software 40 records parameters of each pane in an arranged layout. The management system 20 determines a position of each pane on the GUI 11, and displays each pane in the GUI 11 without defining the position and the size of each pane in advance.

The storage system 30 stores data of the electronic device 1, such as graphical data relating to the GUI 11. In one embodiment, the storage system 30 may be a memory of the electronic device 1, or an external storage card, such as a smart media card, or a secure digital card. The at least one processor 50 executes one or more computerized codes and other applications for the electronic device 1, to provide the functions of the management system 20.

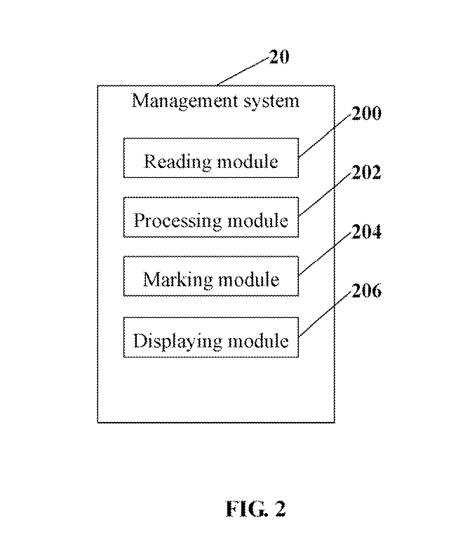

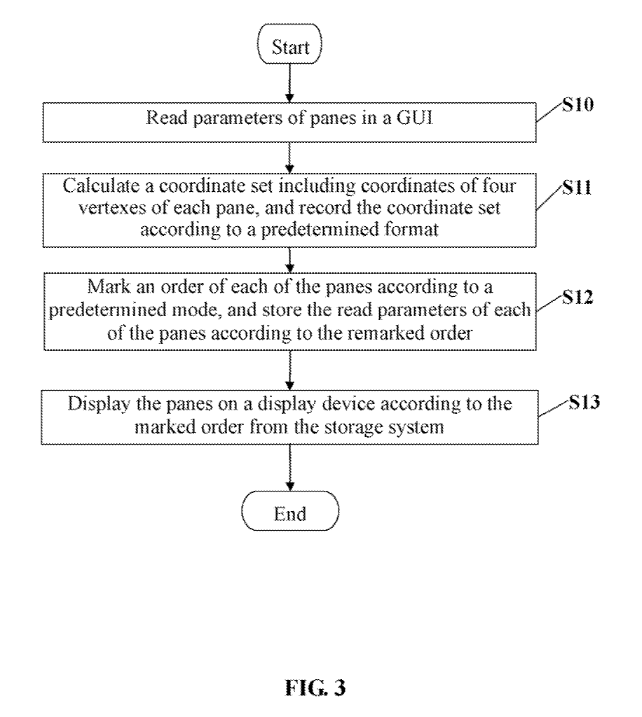

As shown in FIG. 2, the management system 20 includes a reading module 200, a processing module 202, a marking module 204, and a displaying module 206. The one or more modules may comprise computerized instructions in the form of one or more programs that are stored in the storage system 30 and executed by the at least one processor 50 to provide functions of the modules 200, 202, 204, and 206. Details of each of the modules are given in FIG. 3.

FIG. 3 is a flowchart of one embodiment of a method for managing display of GUI 11 of the electronic device 1. Depending on the embodiment, additional steps may be added, others deleted, and the ordering of the steps may be changed.

In step S10, the reading module 200 reads parameters of panes in the GUI 11. In some embodiments, the parameters may include, but are not limited to, coordinates of an upper left vertex, a length and a width of each pane in the arranged layout.

In step S11, the processing module 202 calculates a coordinate set including coordinates of four vertexes of each of the panes, and records the coordinate set according to a predetermined format. In one embodiment, the predetermined format is {coordinates of upper left vertex, coordinates of upper right vertex, coordinates of lower right vertex, coordinates of lower left vertex}. The processing module 202 calculates the coordinate set according to the coordinates of the upper left vertex, of the length and of the width of each of the panes. For example, an X coordinate value of the upper right vertex of one of the panes is equal to a sum of an X coordinate value of the upper left vertex of the pane and the length of the pane, and a Y coordinate value of the upper left vertex of the pane is equal to a Y coordinate value of the upper left vertex. In one embodiment, a coordinate system of the electronic device presets a point in the upper left vertex of the display device 10 as an origin, a right horizontal direction of the display device 10 as a positive direction of an x-axis, and a down vertical direction of the display device 10 as a positive direction of a y-axis.

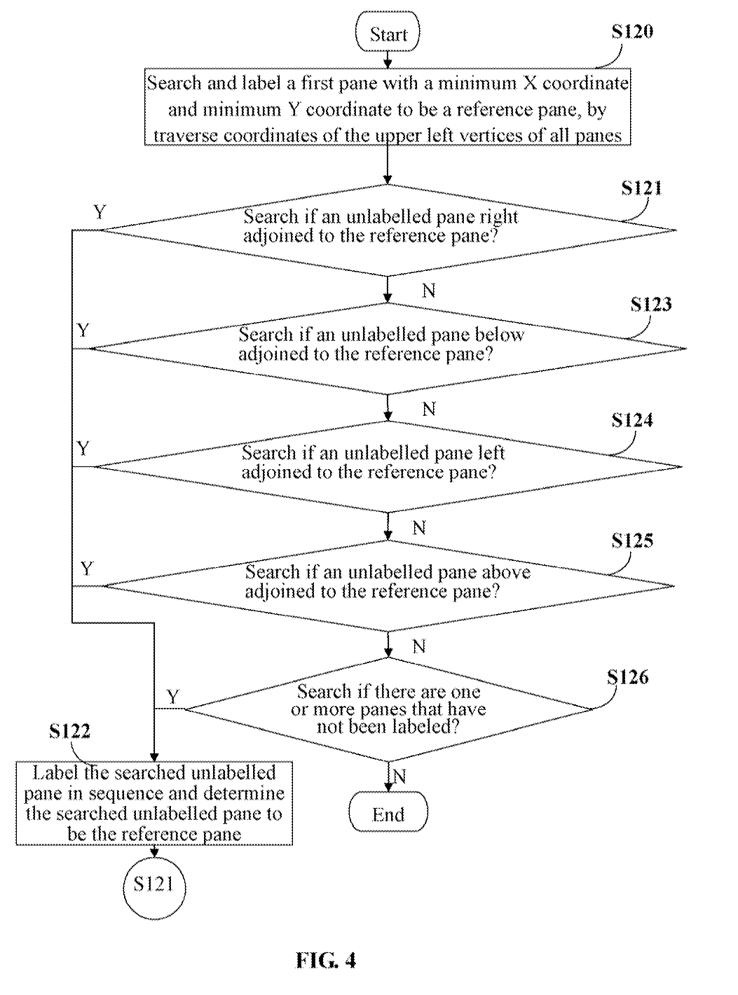

In step S12, the marking module 204 marks an order of each of the panes according to a predetermined mode, and stores the read parameters of each of the panes according to the marked order in the storage system 30. The predetermined mode may be a recursive rotation mode, and detail steps of marking the panes are shown in FIG. 4.

In step S13, when the GUI 11 is displayed on the display device 10, the displaying module 206 reads and displays the panes of the GUI 11 on the display device 10 according to the marked order from the storage system 30. In one embodiment, the GUI 11 may be displayed by another display device (such as video wall or screen), and the panes in the GUI 11 may be displayed one by one in a clockwise rotation mode.

FIG. 4 shows a detailed description of the marking of the panes of the GUI 11. In step S120, the marking module 204 searches for a first pane with a minimum X coordinate value and a minimum Y coordinate value by traversing coordinate values of the upper left vertexes of all the panes, then labels the first pane, and determines the first pane to be a reference pane. The marking module 204 labels the panes according to a natural number sequence, such as, 1, 2, 3, and so on. For example, the marking module 204 labels the first pane with a label of “1”. In other embodiments, the panes can be labeled according to other strings having a preset sequence, such as, a, b, c, and so on.

In step S121, the marking module 204 searches for a first unlabelled pane in the GUI 11 which is right adjoined to the reference pane. If the first unlabelled pane has been found, step S122 is implemented. If no first unlabelled pane has been found, step S123 is implemented. In one embodiment, a difference between an X coordinate value of an upper left vertex of the first unlabelled pane and an X coordinate value of the upper right vertex of the reference pane is less than a preset value, and a Y coordinate value of the upper right vertex of the reference pane is greater than or equal to a Y coordinate value of the upper left vertex and lower than or equal to a Y coordinate value of the left vertex of the first unlabelled pane.

In step S122, the marking module 204 labels the found unlabelled pane in sequence, and determines the searched unlabelled pane to be the reference pane, then step S121 is implemented. For example, the marking module 204 labels the first found unlabelled pane adjoining the right of the first pane with a label of “2”.

In step S123, the marking module 204 searches for a second unlabelled pane in the GUI 11 which is below adjoined to the reference pane. If the second unlabelled pane has been found, step S122 is implemented. If no second unlabelled pane has been found, step S124 is implemented. In one embodiment, a difference between the Y coordinate value of an upper left vertex of the second unlabelled pane and a Y coordinate value of the upper right vertex of the reference pane is less than a preset value, and an X coordinate value of the upper right vertex of the reference pane is greater than or equal to an X coordinate value of the upper left vertex and lower than or equal to an X coordinate value of the upper right vertex of the second unlabelled pane.

In step S124, the marking module 204 searches for a third unlabelled pane in the GUI 11 which is left adjoined to the reference pane. If the third unlabelled pane has been found, step S122 is implemented. If no third unlabelled pane has been found, step S125 is implemented. In one embodiment, a difference between the X coordinate value of an upper left vertex of the third unlabelled pane and an X coordinate value of the lower left vertex of the reference pane is less than a preset value, and a Y coordinate value of the upper right vertex of the reference pane is greater than or equal to a Y coordinate value of the upper right vertex and lower than or equal to a Y coordinate value of the upper right vertex of the third unlabelled pane.

In step S125, the marking module 204 searches for a fourth unlabelled pane in GUI 11 which is above adjoined to the reference pane. If the fourth unlabelled pane has been found, step S122 is implemented. If no fourth unlabelled pane has been found, step S126 is implemented. In one embodiment, a difference between the Y coordinate value of an upper left vertex of the fourth unlabelled pane and a Y coordinate value of the lower left vertex of the reference pane is less than a preset value, and an X coordinate value of the upper left vertex of the reference pane is greater than or equal to an X coordinate value of the lower left vertex and lower than or equal to an X coordinate value of the lower right vertex of the fourth unlabelled pane.

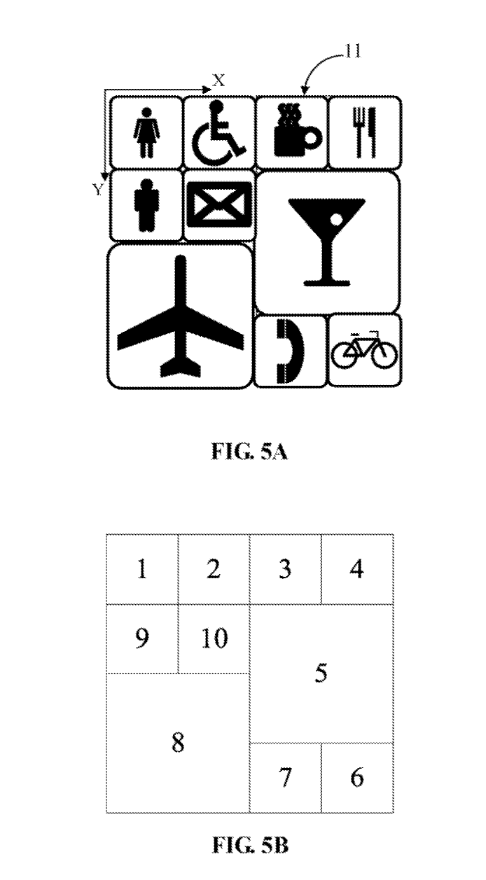

In step S126, the marking module 204 determines whether there are any panes in the GUI 11 that have not been labeled. If there are one or more panes that have not been labeled, step S122 is implemented. If there is no pane that has not been labeled, that is, all of the panes in the GUI 11 have been labeled, the procedure ends. As shown in FIG. 5A, the GUI 11 includes ten panes, and each pane is an icon. After the marking module 204 marks the panes in GUI 11, the panes marked with the order shown in FIG. 5B are stored.

All of the processes described above may be embodied in, and be fully automated via, functional code modules executed by one or more general-purpose processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

The described embodiments are merely possible examples of implementations, set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. A method executable by a processor of an electronic device for managing display of a graphical user interface (GUI) comprising panes, comprising:
reading parameters of the panes of the GUI;
calculating a coordinate set comprising coordinates of four vertexes of each of the panes according to the read parameters;
marking an order of each of the panes according to a predetermined mode, and storing the read parameters of each of the panes according to the marked order in a storage system of the electronic device;
displaying the panes of the GUI according to the marked order on a display device of the electronic device.

2. The method as described in claim 1, wherein the read parameters comprise coordinates of an upper left vertex, a length, and a width of each of the panes.

3. The method as described in claim 1, wherein the predetermined is a recursive rotation mode.

4. The method as described in claim 1, wherein the order of each of the panes is marked according to the predetermined mode by:
(a) searching for a first pane having a minimum X coordinate value and a minimum Y coordinate value by traversing coordinate values of the upper left vertexes of all the panes, labeling the first pane, and determining the first pane to be a reference pane;
(b) searching for a first unlabelled pane in the GUI which is right adjoined to the reference pane, when the first unlabelled pane has been found, step (c) being implemented, or when there is no first unlabelled pane in the GUI, step (d) being implemented;
(c) labeling the found unlabelled pane in sequence, and determining the found unlabelled pane to be the reference pane, returning to step (b);
(d) searching for a second unlabelled pane in the GUI which is below adjoined to the reference pane, when the second unlabelled pane has been found, step (c) being implemented, or when there is no second unlabelled pane, step (e) being implemented;
(e) searching for a third unlabelled pane in the GUI which is left adjoined to the reference pane, when the third unlabelled pane has been found, step (c) being implemented, or when there is no third unlabelled pane, step (f) being implemented;
(f) searching for an fourth unlabelled pane in the GUI which is above adjoined to the reference pane, when the fourth unlabelled pane has been found, step (c) being implemented, or when there is no fourth unlabelled pane, step (g) being implemented; and
(g) determining whether there are one or more panes in the GUI that have not been labeled, when there are one or more panes that have not been labeled, step (c) being implemented, or when there is no pane that has not been labeled, procedure being end.

5. The method as described in claim 4, wherein a difference between an X coordinate value of an upper left vertex of the first unlabelled pane and an X coordinate value of the upper right vertex of the reference pane is less than a preset value, and a Y coordinate value of the upper right vertex of the reference pane is greater than or equal to a Y coordinate value of the upper left vertex and lower than or equal to a Y coordinate value of the left vertex of first the unlabelled pane;
a difference between the Y coordinate value of an upper left vertex of the second unlabelled pane and a Y coordinate value of the upper right vertex of the reference pane is less than a preset value, and an X coordinate value of the upper right vertex of the reference pane is greater than or equal to an X coordinate value of the upper left vertex and lower than or equal to an X coordinate value of the upper right vertex of the second unlabelled pane;
a difference between the X coordinate value of an upper left vertex of the third unlabelled pane and an X coordinate value of the lower left vertex of the reference pane is less than a preset value, and a Y coordinate value of the upper right vertex of the reference pane is greater than or equal to a Y coordinate value of the upper right vertex and lower than or equal to a Y coordinate value of the upper right vertex of the third unlabelled pane;
a difference between the Y coordinate value of an upper left vertex of the fourth unlabelled pane and a Y coordinate value of the lower left vertex of the reference pane is less than a preset value, and an X coordinate value of the upper left vertex of the reference pane is greater than or equal to an X coordinate value of the lower left vertex and lower than or equal to an X coordinate value of the lower right vertex of the fourth unlabelled pane.

6. A non-transitory storage medium having stored thereon instructions that, when executed by a processor, causes the processor to perform a method for managing display of a graphical user interface (GUI) of an electronic device, the method comprising:
reading parameters of panes designed in the GUI;
calculating a coordinate set comprising coordinates of four vertexes of each of the panes according to the read parameters;
marking an order of each of the panes according to a predetermined mode, and storing the read parameters of each of the panes according to the marked order in a storage system of the electronic device;
displaying the panes of the GUI according to the marked order on a display device of the electronic device, when the GUI is displayed on the display device.

7. The non-transitory storage medium as described in claim 6, wherein the read parameters comprises coordinates of an upper left vertex, a length and a width of each of the panes.

8. The non-transitory storage medium as described in claim 6, wherein the predetermined is a recursive rotation mode.

9. The non-transitory storage medium as described in claim 6, wherein the order of each of the panes is marked according to the predetermined mode by:
(a). searching for and labeling a first pane with a minimum X coordinate value and a minimum Y coordinate value by traversing coordinate values of the upper left vertexes of all the panes, and determining the first pane to be a reference pane;
(b). searching for a first unlabelled pane in the GUI which is right adjoined to the reference pane, when the first unlabelled pane has been found, step (c) being implemented, or when there is no first unlabelled pane in the GUI, step (d) being implemented;
(c). labeling the found unlabelled pane in sequence, and determining the found unlabelled pane to be the referenced pane, returning to the step (b);
(d). searching for a second unlabelled pane in the GUI which is below adjoined to the reference pane, when the second unlabelled pane has been found, step (c) being implemented, or when there is no second unlabelled pane, step (e) being implemented;
(e). searching for a third unlabelled pane in the GUI which is left adjoined to the reference pane, when the third unlabelled pane has been found, step (c) being implemented, or when there is no third unlabelled pane, step (f) being implemented;
(f). searching for an fourth unlabelled pane in the GUI which is above adjoined to the reference pane, when the fourth unlabelled pane has been found, step (c) being implemented, or when there is no fourth unlabelled pane, step (g) being implemented;
(g). determining whether there are one or more panes in the GUI that have not been labeled, when there are one or more panes that have not been labeled, step (c) being implemented, or when there is no pane that has not been labeled, procedure ends.

10. The non-transitory storage medium as described in claim 9, wherein a difference between an X coordinate value of an upper left vertex of the first unlabelled pane and an X coordinate value of the upper right vertex of the reference pane is less than a preset value, and a Y coordinate value of the upper right vertex of the reference pane is greater than or equal to a Y coordinate value of the upper left vertex and lower than or equal to a Y coordinate value of the left vertex of first the unlabelled pane;
a difference between the Y coordinate value of an upper left vertex of the second unlabelled pane and a Y coordinate value of the upper right vertex of the reference pane is less than a preset value, and an X coordinate value of the upper right vertex of the reference pane is greater than or equal to an X coordinate value of the upper left vertex and lower than or equal to an X coordinate value of the upper right vertex of the second unlabelled pane;
a difference between the X coordinate value of an upper left vertex of the third unlabelled pane and an X coordinate value of the lower left vertex of the reference pane is less than a preset value, and a Y coordinate value of the upper right vertex of the reference pane is greater than or equal to a Y coordinate value of the upper right vertex and lower than or equal to a Y coordinate value of the upper right vertex of the third unlabelled pane;
a difference between the Y coordinate value of an upper left vertex of the fourth unlabelled pane and a Y coordinate value of the lower left vertex of the reference pane is less than a preset value, and an X coordinate value of the upper left vertex of the reference pane is greater than or equal to an X coordinate value of the lower left vertex and lower than or equal to an X coordinate value of the lower right vertex of the fourth unlabelled pane.

11. An electronic device, comprising:
a display device;
a storage system;
at least one processor to executing one or more programs stored in the storage system for performing a method of managing display of a graphical user interface (GUI) of the electronic device comprising:
reading parameters of panes designed in the GUI;
calculating a coordinate set comprising coordinates of four vertexes of each of the panes according to the read parameters;
marking an order of each of the panes according to a predetermined mode, and storing the read parameters of each of the panes according to the marked order in a storage system of the electronic device;
displaying the panes of the GUI according to the marked order on a display device of the electronic device, when the GUI is displayed on the display device.

12. The electronic device as described in claim 11, wherein the read parameters comprises coordinates of an upper left vertex, a length and a width of each of the panes.

13. The electronic device as described in claim 11, wherein the predetermined is a recursive rotation mode.

14. The electronic device as described in claim 11, wherein the order of each of the panes is marked according to the predetermined mode by:
(a). searching for and labeling a first pane with a minimum X coordinate value and a minimum Y coordinate value by traversing coordinate values of the upper left vertexes of all the panes, and determining the first pane to be a reference pane;
(b). searching for a first unlabelled pane in the GUI which is right adjoined to the reference pane, when the first unlabelled pane has been found, step (c) being implemented, or when there is no first unlabelled pane in the GUI, step (d) being implemented;
(c). labeling the found unlabelled pane in sequence, and determining the found unlabelled pane to be the referenced pane, returning to the step (b);
(d). searching for a second unlabelled pane in the GUI which is below adjoined to the reference pane, when the second unlabelled pane has been found, step (c) being implemented, or when there is no second unlabelled pane, step (e) being implemented;
(e). searching for a third unlabelled pane in the GUI which is left adjoined to the reference pane, when the third unlabelled pane has been found, step (c) being implemented, or when there is no third unlabelled pane, step (f) being implemented;
(f). searching for an fourth unlabelled pane in the GUI which is above adjoined to the reference pane, when the fourth unlabelled pane has been found, step (c) being implemented, or when there is no fourth unlabelled pane, step (g) being implemented;
(g). determining whether there are one or more panes in the GUI that have not been labeled, when there are one or more panes that have not been labeled, step (c) being implemented, or when there is no pane that has not been labeled, procedure being end.

15. The electronic device as described in claim 14 wherein a difference between an X coordinate value of an upper left vertex of the first unlabelled pane and an X coordinate value of the upper right vertex of the reference pane is less than a preset value, and a Y coordinate value of the upper right vertex of the reference pane is greater than or equal to a Y coordinate value of the upper left vertex and lower than or equal to a Y coordinate value of the left vertex of first the unlabelled pane;
a difference between the Y coordinate value of an upper left vertex of the second unlabelled pane and a Y coordinate value of the upper right vertex of the reference pane is less than a preset value, and an X coordinate value of the upper right vertex of the reference pane is greater than or equal to an X coordinate value of the upper left vertex and lower than or equal to an X coordinate value of the upper right vertex of the second unlabelled pane;
a difference between the X coordinate value of an upper left vertex of the third unlabelled pane and an X coordinate value of the lower left vertex of the reference pane is less than a preset value, and a Y coordinate value of the upper right vertex of the reference pane is greater than or equal to a Y coordinate value of the upper right vertex and lower than or equal to a Y coordinate value of the upper right vertex of the third unlabelled pane;
a difference between the Y coordinate value of an upper left vertex of the fourth unlabelled pane and a Y coordinate value of the lower left vertex of the reference pane is less than a preset value, and an X coordinate value of the upper left vertex of the reference pane is greater than or equal to an X coordinate value of the lower left vertex and lower than or equal to an X coordinate value of the lower right vertex of the fourth unlabelled pane.
